(19) United States
(12) Patent Application Publication
(10) Pub. No.: US 2013/0260172 A1
(43) Pub. Date: Oct. 3, 2013

(54) COATED TITANIUM ALLOY SURFACES

(71) Applicants: Paul Dehnhardt Prichard, Greensburg, PA (US); Joel Thomas Dawson, Irwin, PA (US); Mark Rowe, New Derry, PA (US)

(72) Inventors: Paul Dehnhardt Prichard, Greensburg, PA (US); Joel Thomas Dawson, Irwin, PA (US); Mark Rowe, New Derry, PA (US)

(73) Assignee: Kennametal Inc., Latrobe, PA (US)

(21) Appl. No.: 13/437,301

(22) Filed: Apr. 2, 2012

(51) Int. Cl. B32B 5/16; B05D 3/02; B32B 37/14; B05D 7/14

(52) U.S. Cl. 428/627; 427/201; 156/60

(57) ABSTRACT

In one aspect, composite articles are described herein comprising a lightweight, high strength metal substrate and an abrasion resistant coating adhered to the substrate. In some embodiments, a composite article described herein comprises a titanium or titanium alloy substrate and a coating adhered to the substrate, the coating comprising particles disposed in a metal or alloy matrix.

### FIELD

The present invention relates to coatings for metallic substrates and, in particular, to coatings for titanium and titanium alloy substrates.

### BACKGROUND

Coatings are often applied to equipment subjected to demanding environments or operating conditions in efforts to extend the useful lifetime of the equipment. Various coating constructions are available depending on substrate identity and the mode of failure to be inhibited. For example, wear resistant, erosion resistant and corrosion resistant claddings have been developed for heavy and durable substrates of cast iron, low-carbon steels, alloy steels and tool steels. However, given divergent metal chemistries, cladding technologies proven effective for steels are generally unsuitable for lightweight metal systems leading to undesirable cladding properties and premature cladding failure by a variety of mechanisms.

### SUMMARY

In one aspect, composite articles are described herein comprising a lightweight, high strength metal substrate and a wear resistant coating adhered to the substrate. In some embodiments, a composite article comprises a titanium or titanium alloy substrate and a coating adhered to the substrate, the coating comprising particles disposed in a metal or alloy matrix, wherein the coating has an adjusted volume loss of less than 20 mm³ determined according to Procedure E of ASTM G65—Standard Test Method for Measuring Abrasion Using the Dry Sand/Rubber Wheel.

In another aspect, methods of making composite articles are described herein. In some embodiments, a method of making a composite article comprises providing a titanium or titanium alloy substrate, positioning over a surface of the substrate a particulate composition comprising hard particles and metal or alloy powder disposed in a carrier and heating the particulate composition to provide a coating adhered to the titanium or titanium alloy substrate, the coating comprising the hard particles disposed in a metal or alloy matrix, wherein the coating has an adjusted volume loss of less than 20 mm³ determined according to Procedure E of ASTM G65—Standard Test Method for Measuring Abrasion Using the Dry Sand/Rubber Wheel.

In another embodiment, a method of making a composite article comprises providing a titanium or titanium alloy substrate, positioning over a surface of the substrate a particulate composition comprising hard particles disposed in a carrier and positioning over the particulate composition a metal or alloy matrix precursor composition. The particulate composition and the metal or alloy matrix precursor composition are heated to provide a coating adhered to the titanium or titanium alloy substrate, the coating comprising the hard particles disposed in a metal or alloy matrix, wherein the coating has an adjusted volume loss of less than 20 mm³ determined according to Procedure E of ASTM G65—Standard Test Method for Measuring Abrasion Using the Dry Sand/Rubber Wheel. In some embodiments, the carrier of the particulate composition comprises a sheet of polymeric material. The carrier of the particulate composition, in some embodiments, is a liquid.

These and other embodiments are described in greater detail in the detailed description which follows.

### BRIEF DESCRIPTION OF THE DRAWINGS

FIG. 1 is a cross-section metallography of a composite article according to one embodiment described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Composite Articles

In one aspect, composite articles are described herein comprising a lightweight, high strength metal substrate and a wear resistant coating adhered to the substrate. In some embodiments, a composite article comprises a titanium or titanium alloy substrate and a coating adhered to the substrate, the coating comprising particles disposed in a metal or alloy matrix, wherein the coating has an adjusted volume loss of less than 20 mm³ determined according to Procedure E of ASTM G65—Standard Test Method for Measuring Abrasion Using the Dry Sand/Rubber Wheel.

Turning now to components of articles, a composite article described herein comprises a titanium or titanium alloy substrate. In some embodiments, a titanium or titanium alloy substrate has a hexagonal close-packed (hcp) a-phase crystalline structure. In some embodiments, titanium of the substrate is alloyed with one or more a stabilizers comprising elements selected from Groups IIIA-VIA of the Periodic Table. Groups of the Periodic Table described herein are identified according to the CAS designation. In some embodiments, for example, titanium is alloyed with one or more of aluminum, nitrogen, oxygen, carbon, gallium or germanium.

Alternatively, in some embodiments, a titanium or titanium alloy substrate has a body-centered cubic (bcc) β-phase crystalline structure. In some embodiments, titanium of the substrate is alloyed with one or more β stabilizers comprising elements selected from Groups IVA, IB and IVB-VIIIB of the Periodic Table, In some embodiments, for example, titanium of the substrate is alloyed with one or more of molybdenum, vanadium, tantalum, niobium manganese, iron, chromium, cobalt, nickel, copper or silicon.

Further, a titanium alloy substrate, in some embodiments, is an α/β alloy. In some embodiments, titanium is alloyed with one or more a stabilizers and one or more β stabilizers. In one embodiment, for example, an α/β titanium alloy substrate is Ti6Al4V.

Titanium or titanium alloy substrates of composite articles described herein can demonstrate various geometries. In some embodiments, a substrate has a curved, circular or cylindrical geometry. A substrate, in some embodiments, has a polygonal or planar geometry. In some embodiments, a substrate has a geometry suitable for one or more critical wear applications. In some embodiments, for example, titanium or titanium alloy substrates of composite articles described herein comprise flow control components including, but not limited to, valves, impellers, blades, gears, bearings, nozzles, wear components and/or seals.

A composite article described herein comprises a coating adhered to the substrate, the coating comprising particles disposed in a metal or alloy matrix. The metal or alloy matrix of the coating can be selected according to various considerations including, but not limited to, the compositional identity of the substrate and/or the compositional identity of the particles to be disposed in the metal or alloy matrix. In some embodiments, for example, the metal or alloy matrix has a melting point or solidus temperature below the β-transus of the titanium or titanium alloy substrate. Moreover, in some embodiments, the metal or alloy matrix does not solubilize, partially solubilize and/or form interfacial reaction product with the particles disposed in the metal or alloy matrix. In some embodiments, for example, interfacial reaction product is not evident between the metal or alloy matrix and particles disposed in the matrix by optical microscopy at a magnification of 100×.

In some embodiments, the metal or alloy matrix of the coating comprises a brazing metal or brazing alloy. Any brazing metal or alloy not inconsistent with the objectives of the present invention can be used as the matrix of the coating. In some embodiments, for example, an alloy matrix of the coating is a titanium-based alloy having compositional parameters derived from Table I.

TABLE I
Coating Ti-Based Alloy Matrix Compositional Parameters

| Element | Amount (wt %) |
|---|---|
| Zirconium | 0-40 |
| Copper | 0-20 |
| Nickel | 0-25 |
| Molybdenum | 0-2 |
| Titanium | Balance |

In some embodiments, the alloy matrix of the coating is selected from the titanium-based alloys of Table II.

TABLE II
Coating Ti-Based Alloy Matrix Compositional Parameters

| Ti-Based Alloy | Compositional Parameters (wt. %) |
|---|---|
| 1 | Ti—37.5Zr—15Cu—10Ni |
| 2 | Ti—37.5Zr—15Cu—10Ni—1Mo |
| 3 | Ti—24Zr—16Cu—16Ni—0.5Mo |
| 4 | Ti—26Zr—14Cu—14Ni—0.5Mo |
| 5 | Ti—(18-22)Zr—(18-22)Cu—(18-22)Ni |
| 6 | Ti—(18-22)Zr—(18-22)Cu—(18-22)Ni—1Mo |
| 7 | Ti—15Cu—25Ni |
| 8 | Ti—15Cu—15Ni |

Suitable titanium-based alloy brazes are commercially available from Titanium Brazing, Inc. or Cleveland, Ohio.

As described herein, the coating adhered to the substrate comprises particles disposed in the metal or alloy matrix. Particles suitable for use in the coating can be selected according to several considerations including, but not limited to, the desired wear resistance, abrasion resistance, erosion resistance or hardness of the coating and/or the compositional identity of the metal or alloy matrix. In some embodiments, suitable particles are insolvent or substantially insolvent in the metal or alloy matrix and have desirable wetting characteristics inhibiting or precluding particle agglomeration. Additionally, in some embodiments, particles of the coating do not demonstrate interfacial reaction product with the metal or alloy matrix. In one embodiment, for example, interfacial reaction product is not evident between the particles and metal or alloy matrix by optical microscopy at a magnification of 100×.

Particles suitable for use in the metal or alloy matrix of the coating can comprise hard particles. Hard particles of the coating, in some embodiments, comprise particles of metal carbides, metal nitrides, metal carbonitrides, metal oxides, metal borides, metal silicides, cemented carbides, cast carbides or other ceramics or mixtures thereof. In some embodiments, metallic elements of hard particles of the coating comprise aluminum, boron and/or one or more metallic elements selected from Groups IVB, VB and/or VIB of the Periodic Table. Hard particles, in some embodiments, comprise nitrides or carbonitrides of aluminum, boron, silicon, titanium, zirconium, hafnium, tantalum or niobium or mixtures thereof. In some embodiments, hard particles comprise carbides of titanium, tungsten, silicon, boron or mixtures thereof. Additionally, in some embodiments, hard particles comprise borides such as titanium di-boride and tantalum borides, silicides such as MoSi₂ or alumina. Hard particles, in some embodiments, comprise crushed cemented carbide, crushed carbide, crushed nitride, crushed boride or crushed silicide or combinations thereof. In some embodiments, hard particles comprise intermetallic compounds such as nickel aluminide.

Hard particles of the coating can have any size not inconsistent with the objectives of the present invention. In some embodiments, hard particles of the coating have a size distribution ranging from about 0.1 μm to about 1 mm. Hard particles, in some embodiments, have a size distribution ranging from about 1 μm to about 500 μm. In some embodiments, hard particles have a size distribution ranging from about 10 μm to about 300 μm or from about 30 μm to about 150 μm. In some embodiments, hard particles have a size distribution ranging from 10 μm to 100 μm. Hard particles can also demonstrate bimodal or multi-modal size distributions.

Hard particles of the coating can have any desired shape or geometry. In some embodiments, hard particles have spherical or elliptical geometry. In some embodiments, hard particles have a polygonal geometry. In some embodiments, hard particles have irregular shapes, including shapes with sharp edges.

Hard particles can be present in the metal or alloy matrix of the coating in any amount not inconsistent with the objectives of the present invention. Hard particle loading can be varied according to several considerations including, but not limited to, the desired hardness, wear resistance and/or toughness of the coating. In some embodiments, hard particles are present in the metal or alloy matrix in an amount ranging from about 20 volume percent to about 90 volume percent. Hard particles, in some embodiments, are present in an amount ranging from about 30 volume percent to about 85 volume percent. In some embodiments, hard particles are present in an amount ranging from about 40 volume percent to about 70 volume percent. Further, in some embodiments, hard particles are uniformly or substantially uniformly distributed in the metal or alloy matrix.

The coating of a composite article described herein can have any thickness not inconsistent with the objectives of the present invention. In some embodiments, coating thickness is selected according to several considerations, such as the desired wear/abrasion characteristics and/or lifetime of the coating. In some embodiments, the coating has a thickness of at least about 100 μm or at least about 500 μm. The coating, in some embodiments, has a thickness of at least about 750 μm or at least about 1 mm. In some embodiments, the coating has a thickness ranging from about 100 μm to about 5 mm. In some embodiments, the coating has a thickness ranging from about 200 μm to about 2 mm or from about 500 μm to about 1 mm.

The coating, in some embodiments, is fully dense or substantially fully dense. Alternatively, in some embodiments, the coating has porosity. Porosity of the coating, in some embodiments, is less than about 15% by volume. In some embodiments, porosity of the coating is less than about 10% by volume or less than about 5% by volume. In some embodiments, porosity of the coating ranges from about 1% by volume to about 10% by volume. Porosity of the coating, in some embodiments, ranges from about 1% by volume to 5% by volume. In some embodiments, porosity of the coating is uniform or substantially uniform.

The coating of a composite article described herein, in some embodiments, is metallurgically bonded to the titanium or titanium alloy substrate. In some embodiments, a composite article comprises an interfacial transition region between the titanium or titanium alloy substrate and the coating. The interfacial transition region, in some embodiments, has a microstructure or crystalline structure different from the substrate and the coating. Additionally, in some embodiments, the interfacial transition region has a thickness ranging from about 50 μm to about 300 μm or from about 75 μm to about 250 μm.

As described herein, the coating of a composite article, in some embodiments, displays an adjusted volume loss of less than 20 mm³. Values of adjusted volume loss for coatings described herein are determined according to Procedure E of ASTM G65—Standard Test Method for Measuring Abrasion Using the Dry Sand/Rubber Wheel. In some embodiments, the coating demonstrates an adjusted volume loss of less than 15 mm³ or less than 12 mm³. In some embodiments, the coating has an adjusted volume loss of less than 10 mm³ or less than 6 mm³. The coating, in some embodiments, has an adjusted volume loss ranging from about 0.5 mm³ to about 20 mm³ or from about 0.5 mm³ to about 12 mm³. In some embodiments, the coating has an adjusted volume loss ranging from about 0.5 mm³ to about 6 mm³. It is contemplated that various hard particle and metal or alloy matrix combinations will produce coatings having differing adjusted volume loss values.

In view of the disclosure herein, it is within the purview of one of skill in the art to select hard particle and metal or alloy matrix combinations producing coatings having an adjusted volume loss consistent with one or more of the values recited herein. In some cases, for example, hard particle/matrix alloy combinations demonstrating interfacial reaction product and/or hard particle solubilization by the matrix provide compromised coatings having values of adjusted volume loss inconsistent with the same recited herein.

Various coating embodiments comprising hard particles described herein in combination with metal or alloy matrices described herein having an adjusted volume loss consistent with one or more of the values recited herein are contemplated. In some embodiments, for example, a coating described herein comprises a hard particle and alloy matrix combination of titanium carbide particles and/or tungsten carbide particles and an titanium based alloy of Ti-(18-22)Zr-(18-22)Cu-(18-22)Ni. A coating described herein.

In some embodiments, comprises a hard particle and alloy matrix combination of titanium carbide particles and a titanium based alloy of Ti-37.5Zr-15Cu-10Ni.

In some embodiments, a composite article described herein further comprises one or more layers of refractory material deposited by CVD, PVD or combinations thereof over the coating of hard particles disposed in the metal or alloy matrix. CVD and/or PVD layer(s) deposited over the coating, in some embodiments, comprise ceramics, diamond, diamond-like carbon, tungsten carbide or combinations thereof. In some embodiments, CVD and/or PVD layer(s) deposited over the coating comprise aluminum and/or one or more metallic elements selected from Groups IVB, VB and/or VIB of the Periodic Table and one or more non-metallic elements selected from Groups IIIA, IVA, and/or VIA of the Periodic Table. In some embodiments, the refractory layer(s) are deposited over the coating by low temperature or medium temperature CVD.

### II. Methods of Making Composite Articles

In another aspect, methods of making composite articles are described herein. In some embodiments, a method of making a composite article comprises providing a titanium or titanium alloy substrate, positioning over a surface of the substrate a particulate composition comprising hard particles and metal or alloy powder disposed in a carrier and heating the particulate composition to provide a coating adhered to the titanium or titanium alloy substrate, the coating comprising the hard particles disposed in a metal or alloy matrix, wherein the coating has an adjusted volume loss less than 20 mm³.

Turning now to method steps, a method described herein comprises providing a titanium or titanium alloy substrate. In some embodiments, a suitable titanium or titanium alloy substrate comprises any of the titanium or titanium alloy substrates described in section I hereinabove. In some embodiments, for example, a titanium alloy substrate is Ti6Al4V.

After selection of the titanium or titanium alloy substrate, a particulate composition comprising hard particles and metal or alloy powder disposed in a carrier is positioned over the substrate. In some embodiments, hard particles disposed in the carrier can comprise any of the hard particles described in section I hereinabove.

Similarly, in some embodiments, metal or alloy powder disposed in the carrier can comprise any metal or alloy described in section I hereinabove, including the alloys provided in Tables I and II.

In some embodiments, the carrier of the particulate composition comprises an organic material, such as a polymeric material. In some embodiments, the hard particles and metal or alloy powder of the particulate composition are combined with an organic material for the formation of a sheet. For example, in some embodiments, hard particles and powder metal or powder alloy are combined with a polymeric material. The polymeric material and particulate composition are mechanically worked or processed to trap the particulate composition in the polymeric material. In one embodiment, for example, the particulate composition comprising hard particles and a metal or alloy powder is mixed with 3-15% PTFE in volume and mechanically worked to fibrillate the PTFE and trap the particulate composition. Mechanical working can include rolling, ball milling, stretching, elongating, spreading or combinations thereof. In some embodiments, the sheet comprising the powder metal or powder alloy is subjected to cold isostatic pressing. In some embodiments, the resulting sheet comprising the particulate composition has a low elastic modulus and high green strength. In some embodiments, the resulting sheet is flexible and cloth-like in nature. In some embodiments, a sheet comprising the particulate composition is produced in accordance with the disclosure of one or more of U.S. Pat. Nos. 3,743,556, 3,864,124, 3,916,506, 4,194,040 and 5,352,526, each of which is incorporated herein by reference in its entirety.

Hard particles and metal or alloy powder, in some embodiments, are combined with a polymeric material in amounts reflecting the desired compositional percentages of the hard particles and metal or alloy in the finished coating. In some embodiments, for example, hard particles and metal or alloy powder are combined with a polymeric material in amounts consistent with any of the compositional percentages of the hard particles and metal or alloy in the coating recited in section I hereinabove.

Alternatively, the particulate composition comprising hard particles and a metal or alloy powder is combined with a liquid carrier for application to the substrate. In some embodiments, for example, the particulate composition is disposed in a liquid carrier to provide a slurry or paint for application to the substrate. Suitable liquid carriers for particulate compositions described herein comprise several components including dispersion agents, thickening agents, adhesion agents, surface tension reduction agents and/or foam reduction agents. In some embodiments, suitable liquid carriers are aqueous based.

Particulate compositions disposed in a liquid carrier can be applied to surfaces of the substrate by several techniques including, but not limited to, spraying, brushing, flow coating, dipping and/or related techniques. The particulate composition can be applied to the substrate surface in a single application or multiple applications depending on desired thickness of the coating. Moreover, in some embodiments, particulate compositions disposed in liquid carriers can be prepared and applied to substrate surfaces in accordance with the disclosure of U.S. Pat. No. 6,649,682 which is hereby incorporated by reference in its entirety.

After being disposed over a surface of the substrate, the sheet or liquid carrier comprising the particulate composition is heated to provide the coating adhered to the substrate, the coating comprising the hard particles disposed in a metal or alloy matrix formed by melting the metal or alloy powder composition. The sheet or liquid carrier is decomposed or burned off during the heating process. In some embodiments, the substrate and sheet or liquid carrier comprising the particulate composition are heated in a vacuum, inert or reducing atmosphere at a temperature and for a time period where the integrity of the substrate is maintained and the powder metal or powder alloy is densified to the desired amount. In some embodiments, for example, the substrate and sheet or liquid carrier comprising the particulate composition are heated to a temperature below the β transus of the titanium or titanium alloy substrate but above the liquidus temperature of the metal or alloy powder.

Further, as known to one of skill in the art, heating conditions including temperatures, atmosphere and time are dependent on several considerations including the identity of the substrate, the identity of the powder metal or powder alloy and the desired structure of the resulting coating.

In some embodiments, the particulate composition comprising the hard particles and metal or alloy powder is heated under conditions sufficient to produce a fully dense or substantially fully dense coating. Alternatively, the particulate composition, in some embodiments, is heated under conditions to produce a coating having porosity. In some embodiments, for example, the particulate composition is heated under conditions to produce a coating having porosity recited in section I hereinabove. In some embodiments, the particulate composition is subjected to hot isostatic pressing and/or other mechanical processing to achieve the desired densification. In some embodiments, however, a fully dense or substantially fully dense coating can be provided without subjecting the particulate composition to hot isostatic pressing and/or other mechanical processing.

In some embodiments, heating the substrate and particulate composition metallurgically binds the resulting coating to the substrate. In some embodiments, an interfacial transition region is established between the coating and the titanium or titanium alloy substrate. The interfacial transition region can have any property recited in section I hereinabove for the interfacial transition region.

Additionally, in some embodiments, the substrate is cleaned prior to application of the sheet or liquid carrier comprising the particulate composition. Cleaning the substrate can be administered by chemical treatment, mechanical treatment or both. In some embodiments, for example, a substrate is subjected to grit or particle blasting.

In another embodiment, a method of making a composite article described herein comprises providing a titanium or titanium alloy substrate, positioning over a surface of the substrate a particulate composition comprising hard particles disposed in a carrier and positioning over the particulate composition a metal or alloy matrix precursor composition. The particulate composition and the metal or alloy matrix precursor composition are heated to provide a coating adhered to the titanium or titanium alloy substrate, the coating comprising the hard particles disposed in a metal or alloy matrix.

A titanium or titanium alloy substrate can comprise any of the titanium or titanium alloy substrates described in section I hereinabove. Moreover, hard particles disposed in a carrier can comprise any of the hard particles described in section I hereinabove. As described in this section II, a carrier of the hard particles, in some embodiments, comprises an organic material such as a polymeric material. Hard particles and a polymeric material can be combined and formed into a sheet as described in this section II. Alternatively, a carrier of the hard particles, is a liquid as described in this section II.

A metal or alloy matrix precursor composition is positioned over the particulate composition of the hard particles disposed in the carrier. In some embodiments, a metal or alloy matrix precursor composition comprises a metal or alloy foil or sheet. For example, in some embodiments, a foil or thin sheet of the desired metal or alloy composition is positioned over the particulate composition. In some embodiments, an alloy foil or sheet is any alloy described in section I hereinabove, including the alloys provided in Tables I and II.

Alternatively, a metal or alloy matrix precursor composition comprises a metal or alloy powder disposed in a carrier. In some embodiments, a carrier for the metal or alloy powder comprises an organic material, such as a polymeric material. Metal or alloy powder and a polymeric material, for example, can be combined and formed into a sheet as described in this section II. A carrier for the metal or alloy powder, in some embodiments, is a liquid as described in this section II.

The titanium or titanium alloy substrate, particulate composition and metal or alloy matrix precursor composition are heated to provide a coating adhered to the substrate, the coating comprising the hard particles disposed in a metal or alloy matrix formed by melting of the metal or alloy matrix precursor composition. Organic and/or liquid components of the particulate composition and/or matrix precursor composition are decomposed or burned off in the heating process. In some embodiments, the heating process is conducted in a vacuum, inert or reducing atmosphere at a temperature and for a time period wherein the integrity of the substrate is maintained and the metal or alloy matrix precursor composition is densified to the desired amount. For example, in some embodiments, the titanium or titanium alloy substrate, particulate composition and metal or alloy matrix precursor composition are heated to a temperature below the β transus of the substrate but above the liquidus temperature of the metal or alloy matrix precursor composition.

In some embodiments, the particulate composition and the matrix precursor composition are heated under conditions sufficient to produce a fully dense or substantially fully dense coating. Alternatively, the particulate composition and the matrix precursor composition, in some embodiments, are heated under conditions to produce a coating having porosity. In some embodiments, for example, the particulate composition and the matrix precursor composition are heated under conditions to produce a coating having porosity recited in section I hereinabove. In some embodiments, the particulate composition and matrix precursor composition are subjected to hot isostatic pressing and/or other mechanical processing to achieve the desired densification. In some embodiments, however, a fully dense or substantially fully dense coating can be provided without subjecting the particulate composition and the metal or alloy matrix precursor composition to hot isostatic pressing and/or other mechanical processing.

In some embodiments, heating the substrate, particulate composition and matrix precursor composition metallurgically binds the resulting coating to the substrate. In some embodiments, an interfacial transition region is established between the coating and the titanium or titanium alloy substrate. The interfacial transition region can have any property recited in section I hereinabove for the interfacial transition region.

Coatings produced according to methods described herein, in some embodiments, have an adjusted volume loss of less than 20 mm³ determined according to Procedure E of ASTM G65—Standard Test Method for Measuring Abrasion Using the Dry Sand/Rubber Wheel. In some embodiments, a coating produced according to a method described herein has any adjusted volume loss value recited for a coating in section I hereinabove.

Additionally, in some embodiments, hard particles of a coating produced according to a method described herein are uniformly or substantially uniformly distributed in the metal or alloy matrix. In some embodiments, the hard particles are insolvent or substantially insolvent in the metal or alloy matrix. Further, in some embodiments, interfacial reaction product is not evident between the hard particles and the metal or alloy matrix by optical microscopy at a magnification of 100×.

In some embodiments, methods described herein further comprise depositing one or more layers of refractory material over the coating of hard particles disposed in the metal or alloy matrix. The one or more layers of refractory material, in some embodiments, are deposited by CVD, PVD or combinations thereof. In some embodiments, the one or more refractory layers comprise ceramics, diamond, diamond-like carbon, tungsten carbide or combinations thereof. In some embodiments, the CVD and/or PVD layer(s) deposited over the coating comprise aluminum and/or one or more metallic elements selected from Groups IVB, VB and/or VIB of the Periodic Table and one or more non-metallic elements selected from Groups IIIA, IVA and/or VIA of the Periodic Table. In some embodiments, the refractory layer(s) are deposited over the coating by low temperature or medium temperature CVD.

These and other embodiments are further illustrated by the following non-limiting examples.

### Example 1

### Composite Article

A composite article having a construction described herein was produced as follows. Titanium carbide powder (−325 mesh) was mixed with 10% by volume PTFE. The mixture was mechanically worked to fibrillate PTFE and trap the titanium carbide particles and then rolled, thus making a cloth-like flexible abrasive carbide sheet as described in U.S. Pat. No. 4,194,040. A powdered foil which was 200 to 300 microns in thickness with composition 18-22% zirconium, 18-22% copper, 18-22% nickel by weight with the balance titanium was used as the braze material.

The titanium carbide sheet was applied to the surface of a Ti6Al4V substrate by means of adhesive and the powdered braze foil was glued in place over the titanium carbide sheet. The sample was heated in a vacuum furnace to 940-980° C. at a rate of 5-10° C./min for approximately 15 minutes to 60 minutes, during which the braze foil melted and infiltrated the titanium carbide sheet. Upon cooling, a composite coating/cladding was formed comprising a titanium carbide abrasive resistant layer metallurgically bonded to the Ti6Al4V substrate.

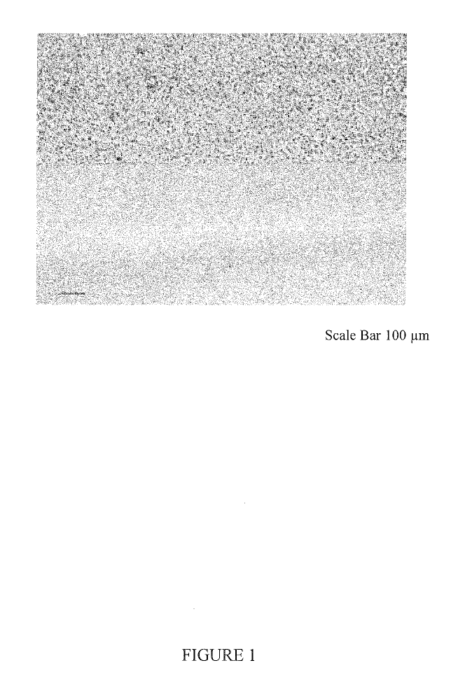

The coating/cladding of the resulting composite article was uniformly bonded to the substrate without significant visual defects (cracks, pores, wrinkles). Metallographic examination of the cross-section at 100× of the coating/cladding of the present example, as illustrated in FIG. 1, indicated the absence of significant defects at the interface between the coating/cladding and substrate. Moreover, the coating demonstrated an adjusted volume loss of 4 mm³ according to Procedure E of ASTM G65—Standard Test Method for Measuring Abrasion Using the Dry Sand/Rubber Wheel.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

That which is claimed is:

1. A composite article comprising:
a titanium or titanium alloy substrate; and
a coating adhered to the substrate, the coating comprising particles disposed in a metal or alloy matrix, wherein the coating has an adjusted volume loss of less than 20 mm³ determined according to Procedure E of ASTM G65—Standard Test Method for Measuring Abrasion Using the Dry Sand/Rubber Wheel.

2. The composite article of claim 1, wherein the coating has adjusted volume loss of less than 12 mm³ according to Procedure E of ASTM G65—Standard Test Method for Measuring Abrasion Using the Dry Sand/Rubber Wheel.

3. The composite article of claim 1, wherein the coating has adjusted volume loss of less than 6 mm³ according to Procedure E of ASTM G65—Standard Test Method for Measuring Abrasion Using the Dry Sand/Rubber Wheel.

4. The composite article of claim 1 further comprising an interfacial transition region between the coating and the titanium or titanium alloy substrate.

5. The composite article of claim 4, wherein the interfacial transition region has a thickness ranging from about 50 μm to about 250 μm.

6. The composite article of claim 4, wherein the interfacial transition region has a microstructure different from the coating and the titanium or titanium alloy substrate.

7. The composite article of claim 1, wherein interfacial reaction product is not evident by optical microscopy at 100× between the particles and the metal or alloy matrix.

8. The composite article of claim 1, wherein the particles are substantially insolvent in the metal or alloy matrix.

9. The composite article of claim 1, wherein the particles of the coating comprise one or more metal carbides, metal nitrides, metal carbonitrides, metal oxides, metal borides, metal silicides, cemented carbides, cast carbides, boron nitrides or mixtures thereof.

10. The composite article of claim 1, wherein the coating has porosity less than 10% by volume.

11. The composite article of claim 1, wherein the coating has porosity less than 5% by volume.

12. The composite article of claim 1, wherein the coating is substantially fully dense.

13. The composite article of claim 1, wherein the particles are uniformly or substantially uniformly distributed in the metal or alloy matrix.

14. The composite article of claim 1, wherein the titanium or titanium alloy substrate comprises α/β phase bulk crystalline structure.

15. The composite of claim 1, wherein the metal or alloy matrix is titanium based.

16. The composite of claim 1, wherein the titanium alloy substrate is Ti6Al4V.

17. The composite article of claim 1 further comprising at least one layer of refractory material deposited over the coating by chemical vapor deposition, physical vapor deposition or a combination thereof.

18. A method of making a composite article comprising:
providing a titanium or titanium alloy substrate;
positioning over a surface of the substrate a particulate composition comprising hard particles and metal or alloy powder disposed in a carrier; and
heating the particulate composition to provide a coating adhered to the titanium or titanium alloy substrate, the coating comprising the hard particles disposed in a metal or alloy matrix, wherein the coating has an adjusted volume loss of less than 20 mm³ determined according to Procedure E of ASTM G65—Standard Test Method for Measuring Abrasion Using the Dry Sand/Rubber Wheel.

19. The method of claim 18, wherein the coating has an adjusted volume loss of less than 12 mm³ determined according to Procedure E of ASTM G65—Standard Test Method for Measuring Abrasion Using the Dry Sand/Rubber Wheel.

20. The method of claim 18, wherein the coating is substantially fully dense.

21. The method of claim 20, wherein the particulate composition is heated under vacuum.

22. The method of claim 18, wherein the carrier of the particulate composition comprises a polymeric material.

23. The method of claim 18, wherein the carrier of the particulate composition is a liquid.

24. The method of claim 18, wherein the coating forms an interfacial transition region with the substrate.

25. The method of claim 18, wherein the heating is administered at a temperature below the β transus temperature of the titanium or titanium alloy substrate.

26. The method of claim 18, wherein interfacial reaction product is not evident between the hard particles and the metal or alloy matrix by optical microscopy at 100×.

27. The method of claim 18, wherein the hard particles are substantially insolvent in the metal or alloy matrix.

28. The method of claim 18, wherein the titanium alloy substrate is Ti6Al4V.

29. A method of making a composite article comprising:
providing a titanium or titanium alloy substrate;
positioning over a surface of the substrate a particulate composition comprising hard particles disposed in a carrier;
positioning over the particulate composition a metal or alloy matrix precursor composition; and
heating the particulate composition and the metal or alloy matrix precursor composition to provide a coating adhered to the titanium or titanium alloy substrate, the coating comprising the hard particles disposed in a metal or alloy matrix, wherein the coating has an adjusted volume loss of less than 12 mm³ as determined according to Procedure E of ASTM G65—Standard Test Method for Measuring Abrasion Using the Dry Sand/Rubber Wheel.

30. The method of claim 31, wherein the metal or alloy matrix precursor composition comprises a metal or alloy sheet or foil.
